(19) United States
(12) Patent Application Publication
(10) Pub. No.: US 2002/0153999 A1
(43) Pub. Date: Oct. 24, 2002

(54) Method and system of remote control and communication through AC power lines

(76) Inventors: Shaohua Wang, Biejing (CN); Rongqi Li, Beijing (CN)

Correspondence Address: WILDMAN, HARROLD, ALLEN & DIXON, 225 WEST WACKER DRIVE, CHICAGO, IL, 60606, US

(21) Appl. No.: 10/102,038

(22) Filed: Mar. 20, 2002

Related U.S. Application Data
(63) Continuation-in-part of application No. PCT/CN00/00276, filed on Sep. 15, 2000.

(30) Foreign Application Priority Data
Sep. 20, 1999 (CN) 99119185.4

(51) Int. Cl. H04M 11/04

(52) U.S. Cl. 340/310.01; 375/295

(57) ABSTRACT

This is a method and system of carrying out remote control and communication through lines of periodical information, especially through AC power lines. It uses the periodical information of the line itself, and establishes in advance a communication protocol. It defines one or more or none signals transmitted at predetermined phases and intervals of the periodical information as one or more determinate information. At any end of the periodical information lines, the transmitting circuit transmits signals of relatively average transmitting energy during a period of time. At the other end, the receiving circuit opens or equivalently opens a receiving signal selective pass gate at phases or intervals where the receiving signals are likely to occur in accordance with the preset rules to accomplish signal receiving. Thus, it increases the anti-interference ability of the circuit, and may be widely used in situations of data communication through AC power lines.

The present invention relates to a method of carrying out remote control, communication through lines of periodical information, especially through AC power lines.

Chinese Patent Application No. 96102461.5 of the present inventors provides a method of carrying out remote control, communication utilizing lines of periodically changed information, especially AC power lines. The method of that application uses one or more specific signals of concentrated energy, short lasting time, and relatively large amplitude at predetermined phases and intervals of the periodical information to carry out communications. This method has two major disadvantages. First, the communication signal may easily cause interference with other equipments due to the concentrated energy, short lasting time, and relatively big amplitude; and this communication method has a wide frequency band. Second, the method of that application provides only the signal of concentrated energy, short lasting time, and relatively large amplitude, but lacks of anti-interference measure. Thus, it is easy to be affected by circuit disturbance.

Therefore, the object of the present invention is to provide a method of carrying out remote control, communication utilizing lines of periodical information, that can reduce the interference with other equipments, and enhance the anti-interference ability in condition of accomplishing the remote control, communication.

In accordance with the present invention, a method of carrying out remote control, communication utilizing lines of periodically changed information, especially AC power lines comprises establishing a communication protocol; defining, under the protocol, one or more or none signal at predetermined phases and intervals of the periodical information as one or more determinate information; according to the protocol, transmitting by a transmitting side, at the predetermined phases and intervals of the periodical information, element information consisting of one or more signals of average energy during a period of time, and information strings consisting of these element information; receiving by a receiving side, under the protocol, the information or information strings transmitted at the predetermined phases and intervals of the periodical information.

The receiving side opens or equivalently opens a selective pass gate for receiving signals at the predetermined phases and intervals of the periodical information, and receives the signals through an automatic gain control; then demodulates the information in accordance with the preset protocol.

The present invention is realized as such. First, it establishes a protocol specified for carrying out communication through lines of periodical information, especially AC power lines. Then it protocols one or more or none signal at predetermined intervals or predetermined phases of the periodical information as one or more determinate information. It may also protocol one or more periodical non-signal information to be of determinate information meaning.

The transmitting or sending side of the present invention sends one or more ringing signals of relatively average energy during a period of time at predetermined phases and intervals of the periodical information according to the protocol. The ringing signal of relatively average energy is achieved by adding a resonance circuit in the transmitting circuit. The resonance circuit may be added at the primary side, secondary side or as an independent circuit in the coupling transformer. Due to the existence of the resonance circuit, when the transmitting circuit is suddenly turned on to generate a ringing signal having somewhat natural attenuation, such a signal will remain relatively average energy during several oscillation periods. Due to the existence of the resonance circuit, the frequency stability of the ringing signal is increased, and the frequency band is narrowed so as to reduce the interference with other equipments.

During communication, the receiving side of the present invention has a selective pass gate circuit for receiving signals. When the selective pass gate is open, the receiving signals can be output; while the receiving signals cannot be output when the selective pass gate is not open. In accordance with the communication protocol, the receiving side knows approximately the phases or intervals of the periodical information at which the transmitting side is likely to transmit signals. Therefore, the selective pass gate will open only at the phases and intervals at which there are possible signals in accordance with the preset protocol. Thus, it may filter out most of circuit interference through the selective pass gate. The opening of the selective pass gate may have various ways. One way is to open directly the selective pass gate to let the input signals pass, and the other way is that the selective pass gate remains open all the time, while the signals at the non-selected period of time will not be discriminated when the input signals pass through the selective pass gate and enter the discriminating circuit. This is equal to non-opening of the selective pass gate.

In accordance with the present invention, because the transmitted signals attenuate through the lines, the amplitudes of the signals may be relatively small, and the lasting time is short. Therefore, after the signals pass through the selective gate, there is an expanding circuit to expand the width of signals, enabling the signals to be effectively and reliably received. However, it will not exceed the scope of the predetermined phases and intervals defined in advance by the communication protocol. Thereafter, in accordance with the expanded receiving signals, the information is demodulated under the communication protocol so as to finish the communication task.

Likewise, the sending or transmitting side may also include a receiving circuit, and the receiving side may also include a transmitting circuit to realize two-way communication. If the communication information contains remote control instruction, the present invention may achieve remote control.

It can be seen from the discussion above that the characteristics of the present invention are:

a. the one or more or none signals at the predetermined phases and intervals of the periodical information are defined to represent one or more determinate information in accordance with the protocol;

b. the signals transmitted at the predetermined phases and intervals of the periodical information are signals of relatively average energy during a period of time that are transmitted through the transmitting circuit with a resonance circuit;

c. the receiving signals of the receiving side is to open or equivalently open the selective pass gate for receiving signals to accomplish the receiving signal in accordance with the communication protocol.

The present invention utilizes the periodical information of the line itself, transmits, at predetermined phases and intervals, one or more or none signals according to the preset communication protocol. During a period of time, the signals of relatively average transmitting energy are realized through adding a resonance circuit in the transmitting circuit. The receiving side in accordance with preset rules opens or equivalently opens the signal selective pass gate at the phases or intervals at which the receiving signals are likely to occur. Thus, it increases largely the circuit ability of anti-interference, so as to achieve the object of the present invention. Since the present method is simple and reliable, it may be adopted widely in situations of data communication through AC power lines; especially suitable for automatic recordation or remote control of electric meters, water meters, gas meters and so on.

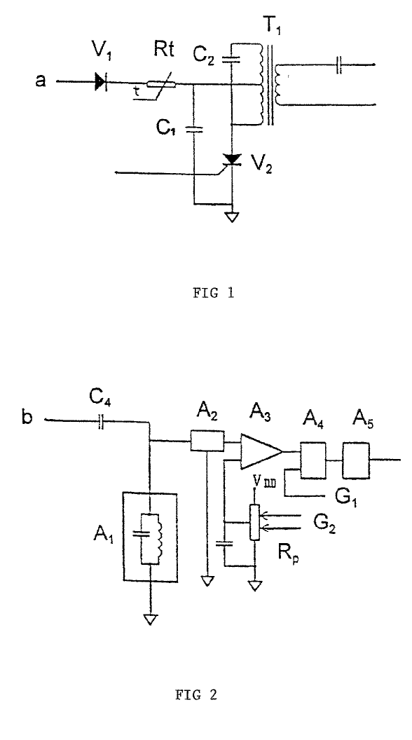

FIG. 1 is an embodiment of the transmitting circuit of the present invention;

FIG. 2 is an embodiment of the receiving circuit of the present invention.

Referring now to the accompanying drawings the preferred embodiments of the present invention are described. However, these embodiments do not intend to limit the present invention.

FIG. 1 is an embodiment of a transmitting circuit of the present invention, wherein T1 is a transmitting coupling transformer, R1 is a thermal sensitive element of positive temperature parameter, V1 is a diode, C1 is a capacitor for providing power to the transmitting circuit, C2 is coupled with the transmitting winding of the transformer T1 to form a resonance circuit, and V2 is a thyratron transistor. The winding of the resonance circuit, may be the transmitting side winding of the coupling transformer T1, or at its split winding, or an independent winding thereof.

FIG. 2 is an embodiment of a receiving circuit of the present invention. A1 is a receiving frequency selection circuit, A2 is a protective circuit that limits the over-high signals at the receiving side, A3 is a comparator, an input terminal of which receives signals and the other terminal is connected with a digital potentiometer Rp. One end of a fixed arm of the digital potentiometer Rp is connected to the common end of the comparator A3, and the other end of the fixed arm of the digital potentiometer Rp is connected to the power supply VDD. When the voltage output from the movable arm of the digital potentiometer Rp increases, the comparison voltage of the comparator A3 increases accordingly such that only higher input signal may be output. This corresponds to the decrease of the sensibility of the receiving signal; on the other hand, it corresponds to the increase of the sensibility of the receiving signal when the comparative voltage of the comparator A3 decreases. This may realize the automatic gain adjustment of receiving signals. The digital potentiometer is controlled by its control end G2. A4 is a selective pass gate, and controlled by the control end G1; A5 is an expanding circuit of receiving signals.

Take an embodiment as an example, on an AC power source of 50 Hz, the declining side of voltage passing zero point is taken as the synchronization starting point, and a communication protocol is set accordingly. The negative half cycle of the AC waveform is divided equally or unequally into 8 or 16 segments as interval regions, and then within each region a selective passing region is set in the scope of width where signals may possibly occur; and the combinations of signals occurred at specified interval positions under the protocol are defined as the starting information of signal strings.

The receiving side expands the received signals through the selective pass gate, and then demodulates directly the information in accordance with the received signal combinations. In order to effectively filter out the interference impacts, the same data may be transmitted repeatedly using dynamic change mode, and then the effectiveness of the information is determined on the basis of voting.

An embodiment of the transmitting circuit is to charge the transmitting power capacitor through the transmitting circuit at the positive half cycle of the AC, and then to transmit signals at the negative half cycle in accordance with the communication protocol.

In an embodiment of the transmitting circuit shown in FIG. 1, the power source of the transmitting circuit is a capacitor. It connects directly to the AC power source through the serial connection of the diode V1 and thermal resistant Rt of positive temperature parameter. The polarity of diode V1 assures that the power capacitor of the transmitting circuit is charged only at the positive half cycle. In the embodiment of the transmitting circuit there is a coupling transformer T1. An end of the transmitting winding of the coupling transformer is connected to the transmitting power source, that is power capacitor C1, and the other end is connected to the driving device V2 of the transmitting circuit. The transmitting driving device V2 is a thyratron transistor.

The embodiment of the transmitting circuit transmits signals only at the negative half cycle of the AC power source. When the transmitting circuit transmits at the negative half cycle, the diode V1 of the transmitting power charging circuit is at a reversed state. The electricity consumed during the transmission is only the amount of electricity stored in the power capacitor C1. After the transmission, the amount of electricity of the power capacitor C1 is discharged below the conducting maintaining current of the thyratron transistor V2 so as to turn off the thyratron transistor. It gets ready for the next transmission. Due to the existence of the thermal sensitive element Rt in the charging circuit, it has protective function to the circuit. The thyratron transistor may remain conducted all the time until the next positive half cycle even if the circuit breakdown occurs. The big current will increase the resistance of the thermal sensitive element Rt of positive temperature parameter so as to achieve the purpose of protecting the circuit safe.

As seen for the description of the transmitting circuit, in the method of carrying out remote control, communication through lines of periodical information, the characteristic of the transmitting circuit is: the transmitting circuit charges the power source at the positive half cycle of the AC, and the transmitting circuit transmits at the negative half cycle. The power source charging circuit of the transmitting circuit is composed of a diode conducted unidirectional and a thermal resistant of positive parameter.

In the method of carrying out remote control, communication through lines of periodical information, the characteristic of the receiving signal is to adjust automatically the gain of the receiving circuit. When the load of the outside power supply is heavy, the amplitudes of the receiving signal and the interference are all reduced, whereby increasing automatically the receiving sensitivity through the circuit gain adjustment; otherwise, it decreases automatically the receiving sensitivity.

The automatic gain adjustment of the receiving circuit is that the receiving circuit, in accordance with the communication protocol, compares the number of actually received signals and the number of signals that should be received in each communication cycle to obtain the parameter of the automatic gain adjustment. When the number of actually received signals is less than the number of signals that should be received in one or more signal cycles, it increases the receiving gain; and otherwise, decreases the receiving gain.

During the automatic gain adjustment, the receiving signal is communicated with an input of a voltage comparator or an amplifier, while the other input end of the voltage comparator or amplifier is connected to a DC voltage source that may be automatically adjusted by the circuit. When the voltage of the DC voltage source increases, the input threshold voltage of the voltage comparator or amplifier increases, and thus the receiving sensibility decreases. Otherwise, when the voltage of the DC voltage source that may be automatically adjusted decreases, the input threshold voltage of the voltage comparator or amplifier decreases, and thus the receiving sensitivity increases.

The DC voltage source that may be automatically adjustable by the circuit is a digital potentiometer. By connecting, respectively, two fixed resistant ends of the digital potentiometer to the voltage source, and by controlling and adjusting the position of the sliding arm of the potentiometer, it creates an adjustable voltage source.

1. A method of carrying out remote control, communication utilizing lines of periodically information, comprising establishing in advance a communication protocol; according to the protocol, defining one or more signals including none signal, at predetermined phases and intervals of the periodical information, as one or more determinate information; according to said protocol, transmitting by a transmitting side, at the predetermined phases and intervals of the periodical information, element information consisting of one or more signals of average energy during a period of time, and information strings consisting of these element information; and receiving by a receiving side, under said protocol, the information transmitted at the predetermined phases and intervals of the periodical information.

2. The remote control and communication method according to claim 1, wherein said receiving side opens or equivalently opens, under said protocol, a selective pass gate for receiving signals at the predetermined phases and intervals of the periodical information, and demodulates the information in accordance with the preset protocol.

3. The remote control and communication method according to claim 1, wherein said receiving side opens or equivalently opens, under said protocol, a selective pass gate for receiving signals at the predetermined phases and intervals of the periodical information, and controls the signal receiving though an automatic gain control, and then demodulates the information in accordance with the preset protocol.

4. The remote control and communication method according to claim 1, wherein said signals of relatively average energy during a period of time transmitted at the predetermined phases and intervals of the periodical information are transmitted through the transmitting circuit with a resonance circuit.

5. The remote control and communication method according to claim 1, wherein said lines of periodical information are AC power lines.

6. The remote control and communication method according to claim 4, wherein said transmitting circuit charges a transmitting power source that provides its power at the positive half cycle of the AC connected therewith, and said transmitting circuit transmits at the negative half cycle o the AC.

7. The remote control and communication method according to claim 3, wherein the automatic gain adjustment of the receiving circuit of the receiving signal is to increase automatically the receiving sensitivity through said circuit automatic gain adjustment, when the load of an outside power supply is heavy, and amplitudes of the receiving signals and interference signals are all reduced; and to decrease automatically the receiving sensitivity when the load of the outside power supply is light, and the amplitudes of the receiving signals and interference signals are relatively big.

8. The remote control and communication method according to claim 3, wherein the automatic gain adjustment of said receiving circuit is that the circuit, in accordance with the communication protocol, compares the number of actually received signals and the number of signals that should be received in each communication cycle to obtain parameters of the automatic gain adjustment; and increases the receiving gain when the number of actually received signals is less than the number of signals that should be received in one or more signal cycle; and otherwise decreases the receiving gain.

9. A system of carrying out remote control and communication utilizing lines of periodically information, particularly AC power lines, comprising at least one transmitting circuit at one end of said lines and at least one receiving circuit at the other end of said lines, said transmitting circuit including a chargeable transmitting power source and a transmitting resonance circuit; said receiving circuit including a selective pass gate and an automatic gain control device, wherein said transmitting circuit transmits, at predetermined phases and intervals of the periodical information under a preset communication protocol, element information consisting of one or more signals of relatively average energy during a period of time, and information strings consisting of these element information, and said receiving circuit opens said selective pass gate for receiving the signals transmitted at the predetermined phases and intervals of the periodical information in accordance with said protocol.

10. The system of carrying out remote control and communication according to claim 9, wherein a charging circuit of the transmitting power source of the transmitting circuit comprises a diode conducted unidirectional and a thermal sensitive resistant of positive temperature parameters, and the charging power source is a charging capacitor.

11. The system of carrying out remote control and communication according to claim 9, wherein said receiving circuit comprises, an input of which receives signals, while the other input end of the voltage comparator is connected to a DC voltage source that may be automatically adjusted by the circuit, and when the voltage of the DC voltage source increases, an input threshold voltage of the voltage comparator or amplifier increases, and the receiving sensibility decreases; and when the voltage of the DC voltage source that may be automatically adjusted decreases, the input threshold voltage of the voltage comparator or amplifier decreases, and the receiving sensitivity increases.

12. The system of carrying out remote control and communication according to claim 11, wherein the DC voltage source being automatically adjustable by the circuit is a digital potentiometer, two fixed resistant ends of the digital potentiometer being connected, respectively, to a fixed voltage source, and an adjustable voltage source is obtained by controlling and adjusting the position of a sliding arm of the potentiometer.
